(19) United States
(12) Patent Application Publication
(10) Pub. No.: US 2023/0124459 A1
(43) Pub. Date: Apr. 20, 2023

(54) ELECTRONIC COMMERCE SYSTEM FOR PROPOSING PERSONALLY-DESIRED TRANSACTION PRICE, AND TRANSACTION METHOD ACCORDING TO SAME

(71) Applicant: BUCHIGO INC., Seoul (KR)

(72) Inventors: Moon Sung CHOI, Gyeonggi-do (KR); Dong Hyuk KIM, Gyeonggi-do (KR)

(21) Appl. No.: 17/912,137

(22) PCT Filed: Mar. 16, 2021
(86) PCT No.: PCT/KR2021/003196

§ 371 Date: Sep. 16, 2022

(30) Foreign Application Priority Data
Mar. 16, 2020 (KR) 10-2020-0032019

(51) Int. Cl. G06Q 30/0207; G06Q 10/087

(52) U.S. Cl. CPC G06Q 30/0222; G06Q 30/0239; G06Q 30/0223; G06Q 10/087; G06Q 2220/00

(57) ABSTRACT

A method for a transaction for proposing a personally-desired transaction price includes inputting a desired transaction price of a commodity or service in a desired price selection part of a consumer user interface for a consumer, loading inventory quantities of the commodity or service stored in a database to determine whether the desired transaction price of the commodity or service corresponds to any one of prices to which a plurality of discount rates are applied and whether the inventory quantity corresponding to the desired transaction price is present, and deleting the desired price selection part from the consumer user interface and displaying a base price of the commodity or service when the desired transaction price corresponds to any one of the prices to which the plurality of discount rates are applied and the inventory quantity corresponding to the desired transaction price is present and payment by the consumer is confirmed.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2021/003196 filed on Mar. 16, 2021, which claims priority to the benefit of Korean Patent Application No. 10-2020-0032019 filed in the Korean Intellectual Property Office on Mar. 16, 2020, the entire contents of which are incorporated herein by reference.

### BACKGROUND

### 1. Technical Field

The present disclosure relates to an electronic commerce system and a transaction method according thereto, the system and the method enabling a consumer to pay a price that he or she is willing to pay and to purchase a commodity or service, without the announcement of a discounted selling price.

### 2. Background Art

The present disclosure relates to an electronic commerce system for proposing a personally-desired transaction price, and a transaction method according thereto. There are a number of preceding materials related to electronic commerce methods in which a seller does not announce a selling price in order to conduct a transaction at a high transaction price.

In Korean Patent Application Publication No. 10-2001-0016321, a seller conceals and inputs a desired price for selling and receives a desired price for purchase from a consumer while the desired price for selling is not exposed in commodity information that the consumer can read. Herein, the following configuration is disclosed: the desired price for selling input by the seller is compared to the desired price for purchase input by the consumer, and when the desired price for purchase by the consumer is higher than the desired price for selling by the seller, a single advertisement is arranged in a line on an advertisement slot machine to immediately indicate that purchase is possible, or when the desired price for purchase by the consumer is lower than the desired price for selling by the seller, several different advertisements are arranged on the advertisement slot machine to indicate that purchase is impossible.

Korean Patent Application Publication No. 10-2017-0030913 discloses the invention in which a ticket for purchasing a particular number of commodities is issued as a ticket purchase price is paid, and information on the commodities that can be purchased with the ticket is provided to a purchaser terminal so as for the commodities to be selected, and if the number of commodities selected through the purchaser terminal is greater than the number of commodities that can be purchased with the ticket, delivery is performed after as many commodities as the number thereof that can be purchased with the ticket are selected through the purchaser terminal.

### SUMMARY

The present disclosure is a revolutionary improvement over the related art, and the present disclosure is directed to providing an electronic commerce system and a transaction method according thereto, wherein a seller exposes only a base price, and even when a consumer purchases only one commodity or service, the consumer purchases the commodity for a desired transaction price that he or she is willing to pay.

According to the present disclosure, an electronic commerce system for proposing a personally-desired transaction price includes: a consumer terminal configured to input a desired transaction price in a desired transaction selection part of a consumer user interface for a consumer; a server; and a database configured to store therein selling information of a commodity or service input from the server, and inventory quantities to which a selling result of the commodity or service is applied, wherein the server includes: an input and output module including a seller user interface configured to input and display the selling information of the commodity or service on a display screen, a price setting module configured to set a plurality of discount rates and discount quantities corresponding to the plurality of discount rates included in the selling information of the commodity or service, and a control communication module configured to: store the plurality of discount rates and the discount quantities corresponding to the plurality of discount rates in the database; determine whether the desired transaction price corresponds to any one of prices to which the plurality of discount rates are applied and whether the inventory quantity corresponding to the desired transaction price is present; and delete the desired transaction selection part from the consumer user interface and display only a base price of the commodity or service when the desired transaction price corresponds to any one of the prices to which the plurality of discount rates are applied and the inventory quantity corresponding to the desired transaction price is present and payment by the consumer is confirmed.

In addition, according to the present disclosure, an electronic commerce system for proposing a personally-desired transaction price includes: a consumer terminal configured to input a desired transaction price in a desired transaction selection part of a consumer user interface for a consumer; a server; a blockchain client server configured to store, in a blockchain node, selling information of a commodity or service input from the server, inventory quantities to which a selling result of the commodity or service is applied, and at least one desired transaction smart contract; and the blockchain node configured to store therein the selling information of the commodity or service, the inventory quantities to which the selling result of the commodity or service is applied, and the at least one desired transaction smart contract, wherein the server includes: an input and output module including a seller user interface configured to input and display the selling information of the commodity or service on a display screen, a price setting module configured to set a plurality of discount rates and discount quantities corresponding to the plurality of discount rates included in the selling information of the commodity or service, and a control communication module configured to: store the plurality of discount rates and the discount quantities corresponding to the plurality of discount rates in the blockchain node; determine whether the desired transaction price corresponds to any one of prices to which the plurality of discount rates are applied and whether the inventory quantity corresponding to the desired transaction price is present; make a request to execute a first desired transaction smart contract stored in the blockchain node when the desired transaction price corresponds to any one of the prices to which the plurality of discount rates are applied and the inventory quantity corresponding to the desired transaction price is present and payment by the consumer is confirmed; and delete the desired transaction selection part from the consumer user interface and display only a base price of the commodity or service as the first desired transaction smart contract stored in the blockchain node is executed.

In addition, according to the present disclosure, a transaction method by means of an electronic commerce system for proposing a personally-desired transaction price includes: inputting a desired transaction price of a commodity or service in a desired price selection part of a consumer user interface for a consumer; loading a plurality of prices to which a plurality of discount rates of the commodity or service are applied, and inventory quantities respectively corresponding to the plurality of prices stored in a database, to determine whether the desired transaction price of the commodity or service corresponds to any one of the prices to which the plurality of discount rates are applied and whether the inventory quantity corresponding to the desired transaction price is present; and deleting the desired price selection part from the consumer user interface and displaying a base price of the commodity or service when the desired transaction price corresponds to any one of the prices to which the plurality of discount rates are applied and the inventory quantity corresponding to the desired transaction price is present and payment by the consumer is confirmed.

In addition, according to the present disclosure, a transaction method by means of an electronic commerce system for proposing a personally-desired transaction price includes: inputting a desired transaction price of a commodity or service in a desired price selection part of a consumer user interface for a consumer; loading a plurality of prices to which a plurality of discount rates of the commodity or service are applied, and inventory quantities respectively corresponding to the plurality of prices stored in a blockchain node, to determine whether the desired transaction price corresponds to any one of the prices to which the plurality of discount rates are applied and whether the inventory quantity corresponding to the desired transaction price is present; making a request to execute a first desired transaction smart contract stored in the blockchain node when the desired transaction price corresponds to any one of the prices to which the plurality of discount rates are applied and the inventory quantity corresponding to the desired transaction price is present and payment by the consumer is confirmed; and deleting a desired transaction selection part from the consumer user interface and displaying only a base price of the commodity or service as the first desired transaction smart contract stored in the blockchain node is executed.

According to the present disclosure, a seller exposes only a base price, and when a consumer purchases only one commodity or service, the consumer can purchase the commodity or service for a price that he or she is willing to pay.

In addition, according to the present disclosure, a consumer can purchase a commodity or service only when the consumer inputs any one of prices to which a plurality of discount rates of the commodity or service input by a seller are applied.

In addition, according to the present disclosure, a plurality of discount rates of a commodity or service and discount quantities corresponding to the plurality of discount rates input by a seller are fixed, so the commodity or service can be purchased for prices to which the plurality of discount rates are applied only until the discount quantities of inventory are present.

In addition, according to the present disclosure, only when with respect to a plurality of discount rates of a commodity or service and discount quantities corresponding to the plurality of discount rates input by a seller, a desired transaction price input by a consumer corresponds to prices to which the plurality of discount rates are applied and the inventory quantity is present, the commodity or service is sold and a desired price transaction selection part is deleted from a consumer user interface, thereby minimizing the possibility that the discount rates are announced to the consumer.

In addition, according to the present disclosure, when with respect to a plurality of discount rates of a commodity or service and discount quantities corresponding to the plurality of discount rates input by a seller, a desired transaction price input by a consumer corresponds to prices to which the plurality of discount rates are applied and the inventory quantity is present, a first desired transaction smart contract stored in a blockchain node is executed to sell the commodity or service and a desired price transaction selection part is deleted from a consumer user interface, thereby achieving automation without changing the discount rates and the discount quantities once set by the seller.

In addition, according to the present disclosure, when with respect to a plurality of discount rates of a commodity or service and discount quantities corresponding to the plurality of discount rates input by a seller, an inventory quantity corresponding to a desired transaction price initially input by a consumer is not present or the desired transaction price does not correspond to the plurality of discount rates, but the inventory quantity corresponding to a price other than the desired transaction price initially input by the consumer is present, a second desired transaction smart contract stored in a blockchain node is executed to give the consumer the opportunity to input a desired transaction price once more. Next, when the inventory quantity is present, the commodity or service is sold and a desired price transaction selection part is deleted from a consumer user interface, thereby giving the consumer one more opportunity to make a purchase for a discounted price without announcing the prices.

In addition, according to the present disclosure, when with respect to a plurality of discount rates of a commodity or service and discount quantities corresponding to the plurality of discount rates input by a seller, an inventory quantity corresponding to a desired transaction price input again by a consumer is not present or the desired transaction price does not correspond to the plurality of discount rates, a third desired transaction smart contract stored in a blockchain node is executed to delete a desired price transaction selection part from a consumer user interface, whereby the prices are not announced in any case.

### BRIEF DESCRIPTION OF THE DRAWINGS

FIG. 1 is a diagram illustrating a first exemplary embodiment of an electronic commerce system for proposing a personally-desired transaction price according to the present disclosure.

FIG. 2 is a diagram illustrating a second exemplary embodiment of an electronic commerce system for proposing a personally-desired transaction price according to the present disclosure.

FIG. 3 is a diagram illustrating a screen for inputting selling information in a seller user interface, in an electronic commerce system for proposing a personally-desired transaction price according to the present disclosure.

FIG. 4 is a first diagram illustrating a consumer user interface, in an electronic commerce system for proposing a personally-desired transaction price according to the present disclosure.

FIG. 5 is a second diagram illustrating a consumer user interface, in an electronic commerce system for proposing a personally-desired transaction price according to the present disclosure.

FIG. 6A is a diagram illustrating the signal flow when selling information of a commodity or service is registered in a server, in the first exemplary embodiment of an electronic commerce system for proposing a personally-desired transaction price according to the present disclosure.

FIG. 6B is a diagram illustrating the signal flow when selling information of a commodity or service is registered in a blockchain node, in the second exemplary embodiment of an electronic commerce system for proposing a personally-desired transaction price according to the present disclosure.

FIG. 7A is a first diagram illustrating a first exemplary embodiment of a transaction method by means of an electronic commerce system for proposing a personally-desired transaction price according to the present disclosure.

FIG. 7B is a second diagram illustrating the first exemplary embodiment of a transaction method by means of an electronic commerce system for proposing a personally-desired transaction price according to the present disclosure.

FIG. 7C is a third diagram illustrating the first exemplary embodiment of a transaction method by means of an electronic commerce system for proposing a personally-desired transaction price according to the present disclosure.

FIG. 8A is a first diagram illustrating a second exemplary embodiment of a transaction method by means of an electronic commerce system for proposing a personally-desired transaction price according to the present disclosure.

FIG. 8B is a second diagram illustrating the second exemplary embodiment of a transaction method by means of an electronic commerce system for proposing a personally-desired transaction price according to the present disclosure.

FIG. 8C is a third diagram illustrating the second exemplary embodiment of a transaction method by means of an electronic commerce system for proposing a personally-desired transaction price according to the present disclosure.

FIG. 8D is a fourth diagram illustrating the second exemplary embodiment of a transaction method by means of an electronic commerce system for proposing a personally-desired transaction price according to the present disclosure.

### DETAILED DESCRIPTION

Hereinafter, preferred embodiments of the present disclosure will be described with reference to the accompanying drawings.

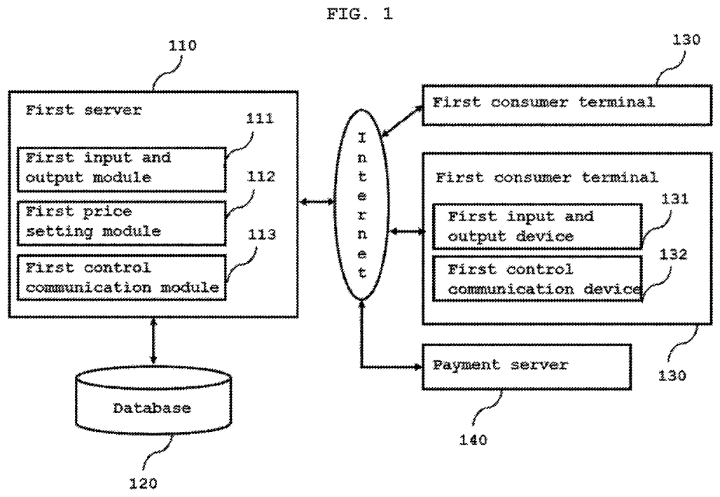

According to FIG. 1, a first exemplary embodiment of an electronic commerce system of the present disclosure includes: a first consumer terminal 130 configured to input a desired transaction price in a desired transaction selection part 410, 510 of a consumer user interface; a first server 110; and a database 120 configured to store therein selling information of a commodity or service input from the first server 110, and inventory quantities to which a selling result of the commodity or service is applied.

The first consumer terminal 130 may access the first server 110 over a network, of which examples include the Internet, and may check the selling information in the desired transaction selection part 410, 510 of the consumer user interface, and may select a desired transaction.

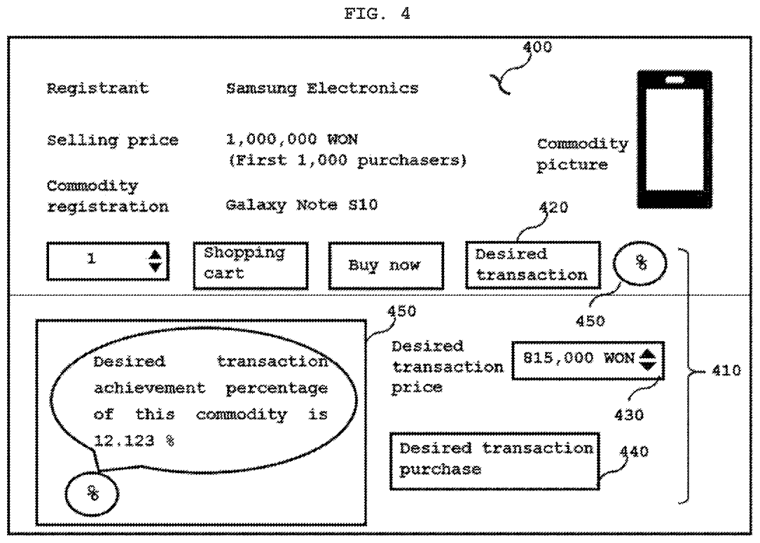

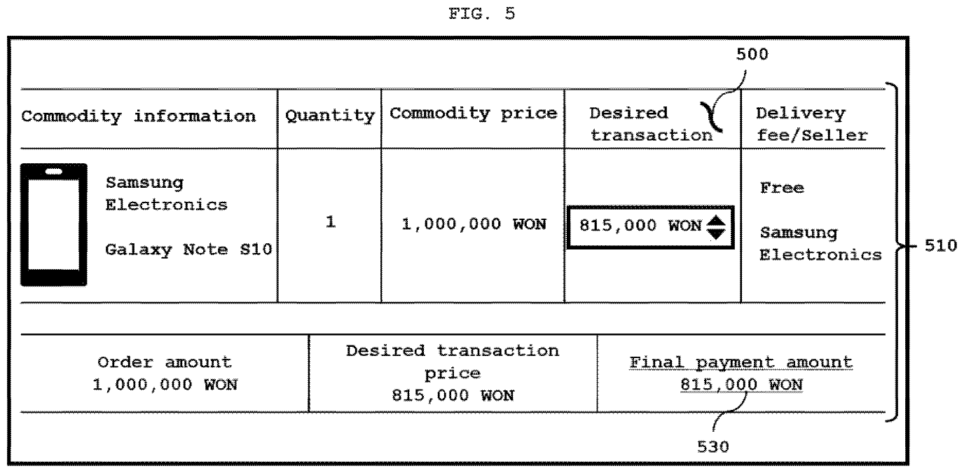

The consumer user interface will be described in detail below with reference to FIGS. 4 and 5.

According to FIG. 1, the first server 110 includes a first input and output module 111, and the first input and output module 111 includes a seller user interface for inputting and displaying the selling information of the commodity or service on a display screen.

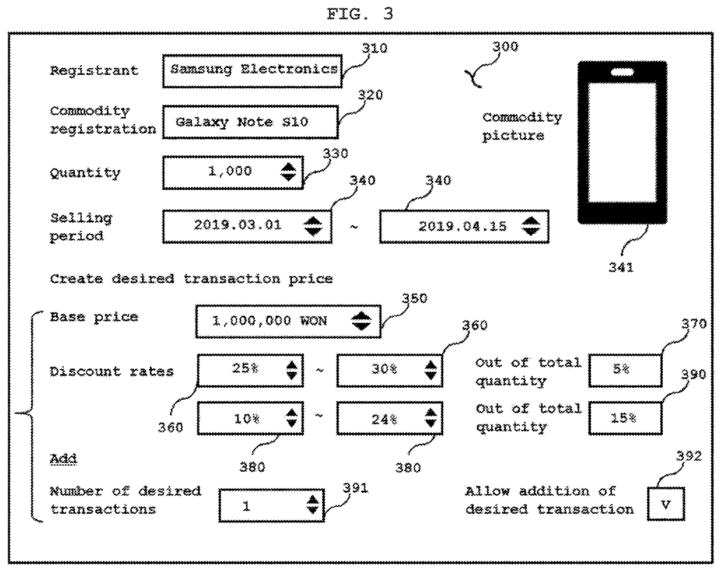

The seller user interface will be described in detail with reference to FIG. 3.

According to FIG. 1, the first server 110 includes a first price setting module 112 configured to set a plurality of discount rates and discount quantities corresponding to the plurality of discount rates included in the selling information of the commodity or service.

As an example, the plurality of discount rates include at least one discount section, and the discount section means a section that is generated including two different discount rates and connecting the two different discount rates compared with a base price of the commodity or service.

According to FIG. 1, the first server 110 further includes a first control communication module 113 configured to store the plurality of discount rates and the discount quantities corresponding to the plurality of discount rates in the database 120, and to determine whether the desired transaction price corresponds to any one of prices to which the plurality of discount rates are applied and whether the inventory quantity corresponding to the desired transaction price is present, and to delete the desired transaction selection part 410, 510 from the consumer user interface and display only a base price of the commodity or service when the desired transaction price corresponds to any one of the prices to which the plurality of discount rates are applied and the inventory quantity corresponding to the desired transaction price is present and payment by the consumer is confirmed.

As an example, the first control communication module 113 is further configured to: display a desired transaction purchase input part 440 as an active window in the consumer user interface when the inventory quantity corresponding to the desired transaction price is not present, but the inventory quantity corresponding to a price other than the desired transaction price among the prices to which the plurality of discount rates are applied is present; display a desired transaction purchase payment window in the consumer user interface when the consumer enters the desired transaction purchase input part 440; display a desired transaction input part 420 and a desired transaction price input part 430, 520 that have been displayed as inactive windows, as active windows when the consumer completes payment; load the inventory quantities stored in the database 120 when the consumer enters a desired transaction in the desired transaction input part 420 and inputs a desired transaction price in the desired transaction price input part 430, 520, so as to determine whether the desired transaction price corresponds to any one of the prices to which the plurality of discount rates are applied and whether the inventory quantity corresponding to the desired transaction price is present; and delete the desired price selection part 410, 510 from the consumer user interface and display only the base price of the commodity or service when the desired transaction price corresponds to any one of the prices to which the plurality of discount rates are applied and the inventory quantity corresponding to the desired transaction price is present.

As an example, the first control communication module 113 is further configured to store, when the desired transaction price corresponds to any one of the prices to which the plurality of discount rates are applied and the inventory quantity corresponding to the desired transaction price is present and the payment by the consumer is confirmed, the inventory quantity reduced by a sales quantity and the discount rates of the respective inventory quantities in the database 120.

As an example, the first control communication module 113 is further configured to delete the desired price selection part 410, 510 from the consumer user interface and display only the base price of the commodity or service when the inventory quantities corresponding to the prices to which the plurality of discount rates are applied are not present or when the inventory quantity of the price corresponding to the desired transaction price input by the consumer is not present after the desired transaction input part 420 and the desired transaction price input part 430, 520 that have been displayed as the inactive windows are displayed as the active windows.

According to FIG. 1, the first exemplary embodiment of the electronic commerce system of the present disclosure further includes a payment server 140 that exactly calculates the cost required for a transaction.

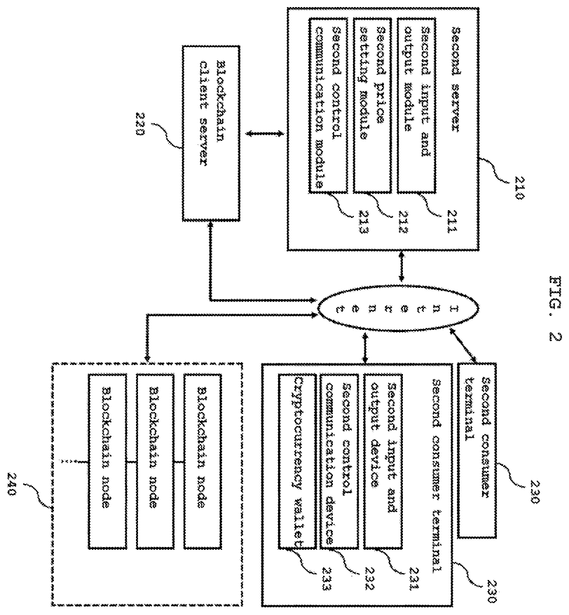

According to FIG. 2, a second exemplary embodiment of the electronic commerce system of the present disclosure includes: a second consumer terminal 230 configured to input a desired transaction price in a desired transaction selection part 410, 510 of a consumer user interface; a second server 210; a blockchain client server 220 configured to store, in a blockchain node 240, selling information of a commodity or service input from the second server 210, and inventory quantities to which a selling result of the commodity or service is applied, and at least one desired transaction smart contract; and the blockchain node 240 configured to store therein the selling information of the commodity or service, the inventory quantities to which the selling result of the commodity or service is applied, and the at least one desired transaction smart contract.

The second consumer terminal 230 may access the second server 210 over a network, of which examples include the Internet, and may check the selling information in the desired transaction selection part 410, 510 of the consumer user interface, and may input a desired transaction.

The consumer user interface will be described in detail below with reference to FIGS. 4 and 5.

According to FIG. 2, the second server 210 includes a second input and output module 211, and the second input and output module 211 includes a seller user interface for inputting and displaying the selling information of the commodity or service on a display screen.

The seller user interface will be described in detail below with reference to FIG. 3.

According to FIG. 2, the second server 210 includes a second price setting module 212 configured to set a plurality of discount rates and discount quantities corresponding to the plurality of discount rates included in the selling information of the commodity or service.

According to FIG. 2, the second server 210 further includes a second control communication module 213 configured to: store the plurality of discount rates and the discount quantities corresponding to the plurality of discount rates in the blockchain node 240; determine whether the desired transaction price corresponds to any one of prices to which the plurality of discount rates are applied and whether the inventory quantity corresponding to the desired transaction price is present; make a request to execute a first desired transaction smart contract stored in the blockchain node 240 when the desired transaction price corresponds to any one of the prices to which the plurality of discount rates are applied and the inventory quantity corresponding to the desired transaction price is present and payment by the consumer is confirmed; and delete the desired transaction selection part 410, 510 from the consumer user interface and display only a base price of the commodity or service as the first desired transaction smart contract stored in the blockchain node 240 is executed.

As an example, the second control communication module 213 is further configured to: make a request to execute a second desired transaction smart contract stored in the blockchain node 240 when the inventory quantity corresponding to the desired transaction price is not present, but the inventory quantity corresponding to a price other than the desired transaction price among the prices to which the plurality of discount rates are applied is present; display a desired transaction purchase input part 440 as an active window in the consumer user interface as the second desired transaction smart contract is executed; display a desired transaction purchase payment window in the consumer user interface when the consumer enters the desired transaction purchase input part 440; display a desired transaction input part 420 and a desired transaction price input part 430, 520 that have been displayed as inactive windows, as active windows when the consumer completes payment; load the inventory quantities stored in the blockchain node 240 when the consumer enters a desired transaction in the desired transaction input part 420 and inputs a desired transaction price in the desired transaction price input part 430, 520, so as to determine whether the desired transaction price corresponds to any one of the prices to which the plurality of discount rates are applied and whether the inventory quantity corresponding to the desired transaction price is present; and delete the desired price selection part 410, 510 from the consumer user interface and display only the base price of the commodity or service when the desired transaction price corresponds to any one of the prices to which the plurality of discount rates are applied and the inventory quantity corresponding to the desired transaction price is present and payment by the consumer is confirmed.

As an example, the second control communication module 213 is further configured to store, when the desired transaction price corresponds to any one of the prices to which the plurality of discount rates are applied and the inventory quantity corresponding to the desired transaction price is present and the payment by the consumer is confirmed, the inventory quantity reduced by a sales quantity and the discount rates of the respective inventory quantities in the blockchain node 240 as the first or second desired transaction smart contract stored in the blockchain node 240 is executed.

As an example, the second control communication module 213 is further configured to: make a request to execute a third desired transaction smart contract stored in the blockchain node 240 when the inventory quantities corresponding to the prices to which the plurality of discount rates are applied are not present or when the inventory quantity of the price corresponding to the desired transaction price input by the consumer is not present after the desired transaction input part 420 and the desired transaction price input part 430, 520 that have been displayed as the inactive windows are displayed as the active windows; and delete the desired price selection part 410, 510 from the consumer user interface and display only the base price of the commodity or service as the third desired transaction smart contract stored in the blockchain node 240 is executed.

According to FIG. 2, the second consumer terminal 230 may include a cryptocurrency wallet 233 for exactly calculating the cost required for a transaction.

According to FIG. 3, a seller may input selling information of the commodity or service through a display screen 300 of a seller user interface. Furthermore, the selling information of the commodity or service includes at least one of the following: a seller 310, a name 320 of the commodity or service, a total discount quantity 330, a selling period 340, a commodity picture 341, a base price 350 of the commodity or service, discount rates 360 of a first discount section, quantity information 370 corresponding to the first discount section, discount rates 380 of a second discount section, quantity information 390 corresponding to the second discount section, the number of times 391 that desired transaction inputs are allowed, and whether 392 to allow additional input of a desired transaction.

According to FIG. 3, as an example, the seller user interface displays the selling information of the Samsung Galaxy X model.

The first and second price setting modules 112 and 212 shown in FIGS. 1 and 2 include the seller user interface 350 to 392 for inputting a plurality of discount rates of the commodity or service and discount quantities corresponding to the plurality of discount rates on the display screen 300 shown in FIG. 3. Furthermore, the seller user interface includes at least one of the following: the base price 350 of the commodity or service, the discount rates 360 of the first discount section, the quantity information 370 corresponding to the first discount section, the discount rates 380 of the second discount section, the quantity information 390 corresponding to the second discount section, the number of times 391 that desired transaction inputs are allowed, and whether 392 to allow additional input of a desired transaction.

In addition, in the electronic commerce system of the present disclosure and the transaction method according thereto, a plurality of discount rates of the commodity or service and discount quantities corresponding to the plurality of discount rates set by the first and second price setting modules 112 and 212 are not announced, so there is no way for a consumer to know the plurality of discount rates and the discount quantities. Therefore, the consumer purchases the commodity or service without knowing discount conditions at all.

According to FIG. 3, as an example, the seller user interface displays discount conditions of the Samsung Galaxy X model on the display screen 300.

According to FIG. 3, the base price of the commodity is the maximum value of the prices of the commodity. For example, the commodity base price of Galaxy X is 1,000,000 won.

According to FIG. 3, as an example, examples of a first discount section and first quantity information include a first discount section (700,000 won to 750,000 won) corresponding to a discount section generated including two different discount rates (for example, 25% and 30%) and connecting the two different discount rates (25% and 30%) compared with the base price of the commodity, and include quantity information (5%: 50 pieces) of the commodity having the prices of the first discount section.

According to FIG. 3, as an example, examples of a second discount section and second quantity information include a second discount section (760,000 won to 900,000 won) corresponding to a discount section generated including two different discount rates (for example, 10% and 24%) and connecting the two different discount rates (10% and 24%) compared with a reference price of the commodity, and include quantity information (15%: 150 pieces) of the commodity having the prices of the second discount section.

As an example, the base price of the Samsung Galaxy X that the electronic commerce system of the present disclosure provides is 1,000,000 won, the total quantity is 1,000 pieces, and the quantity at the base price accounts for 80% of the total quantity, so the quantity at the base price is 800 pieces.

According to FIG. 3, the electronic commerce system of the present disclosure may provide 50 pieces of the Samsung Galaxy X (5% of the total quantity) at discount prices ranging from 700,000 won to 750,000 won according to the first discount section (25% to 30%).

According to FIG. 3, the electronic commerce system of the present disclosure may provide 150 pieces of the Samsung Galaxy X (15% of the total quantity) at discount prices ranging from 760,000 won to 900,000 won according to the second discount section (10% to 24%).

Accordingly, when a desired transaction price of the Samsung Galaxy X of 700,000 won to 750,000 won, of 760,000 won to 900,000 won, or of 1,000,000 won is input in the consumer user interface and the inventory quantity is present, the consumer may purchase the Samsung Galaxy X.

According to FIG. 1, the first consumer terminal 130 includes a first input and output device 131 configured to select a commodity or service that a consumer wants to purchase, and to input and output a price, and a first control communication device 132 configured to communicate with the first server 110 with respect to selling information of the commodity or service input by the consumer to the first input and output device 131, and to control the first input and output device 131.

According to FIG. 2, the second consumer terminal 230 includes a second input and output device 231 configured to select a commodity or service that a consumer wants to purchase, and to input and output a price, and a second control communication device 232 configured to communicate with the second server 210 with respect to selling information of the commodity or service input by the consumer to the second input and output device 231, and to control the second input and output device 231.

According to FIG. 1, the first input and output device 131 of the first consumer terminal 130 includes a display screen 400 shown in FIG. 4. Furthermore, a consumer user interface on the display screen 400 shown in FIG. 4 includes a desired transaction input part 420, a desired transaction price input part 430, a desired transaction purchase input part 440, and a desired price transaction achievement percentage display part 450.

According to FIG. 2, the second input and output device 231 of the second consumer terminal 230 includes a display screen 500 shown in FIG. 5. Furthermore, a consumer user interface on the display screen 500 shown in FIG. 5 includes a desired transaction price input part 520 and a payment amount display part 530.

The consumer user interfaces may be provided by the first or second server 110 or 210 and displayed on the first or second consumer terminal 130 or 230.

According to FIG. 3, the desired transaction selection parts 410 and 510 include the desired transaction input part 420, the desired transaction price input parts 430 and 520, the desired transaction purchase input part 440, the desired price transaction achievement percentage display part 450, and the payment amount display part 530 of the consumer user interfaces shown in FIGS. 4 and 5.

Furthermore, the first and second control communication devices 132 and 232 of the first and second consumer terminals 130 and 230 shown in FIGS. 1 and 2 respectively transmit, to the first and second servers 110 and 210, a desired transaction, desired transaction prices, and desired transaction purchase respectively input in the desired transaction input part 420, the desired transaction price input parts 430 and 520, and the desired transaction purchase input part 440 of the consumer user interfaces shown in FIGS. 4 and 5. A desired price transaction achievement percentage and a payment amount are respectively received from the first and second servers 110 and 210 and displayed in the desired price transaction achievement percentage display part 450 and the payment amount display part 530 of the consumer user interfaces.

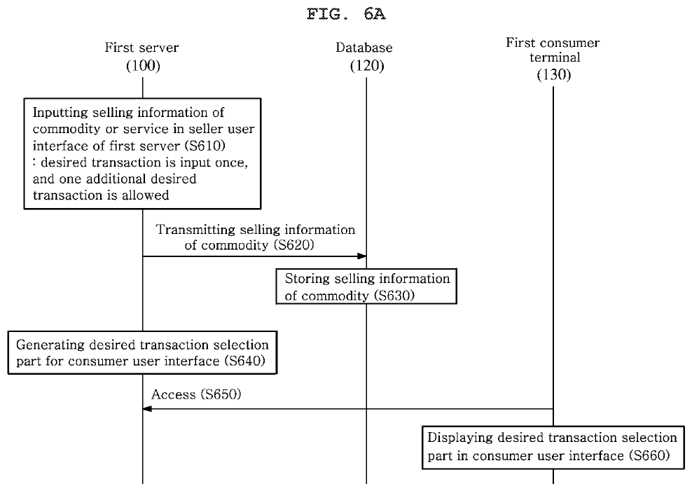

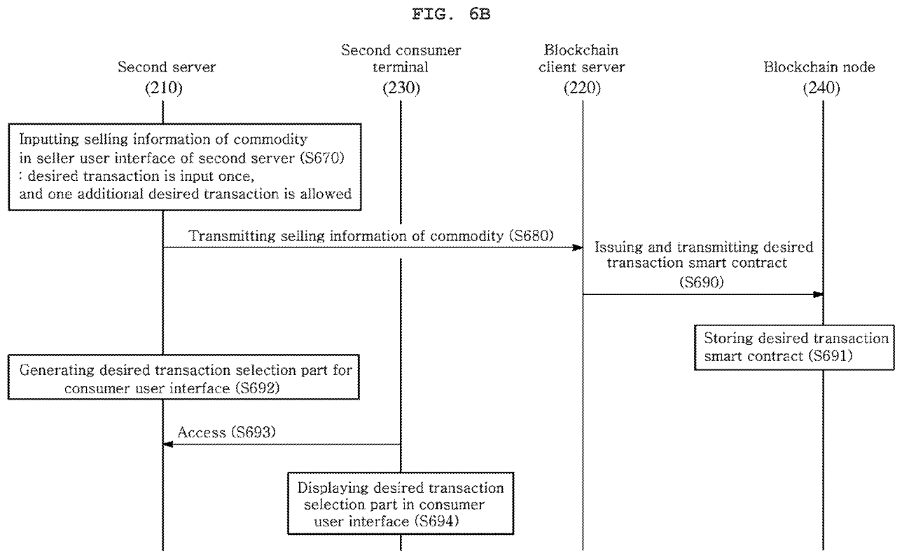

According to FIG. 6A, the signal flow when selling information of the commodity or service is registered in the first server 110 includes inputting selling information of a commodity or service in the seller user interface of the first server 110 in step S610, transmitting the selling information of the commodity or service input from the first server 110 to the database 120 in step S620, storing the selling information of the commodity or service transmitted to the database 120 in the database 120 in step S630, generating the desired transaction selection part 410, 510 for the consumer user interface by the first server 110 in step S640, accessing the first server 110 by the first consumer terminal 130 in step S650, and displaying the desired transaction selection part 410, 510 in the consumer user interface of the first consumer terminal 130 in step S660.

According to FIG. 6B, the signal flow when selling information of the commodity or service is registered in the blockchain node 240 includes inputting selling information of a commodity or service in the seller user interface of the second server 210 in step S670, transmitting the selling information of the commodity or service input from the second server 210 to the blockchain client server 220 in step S680, issuing at least one desired transaction smart contract from the received selling information of the commodity or service by the blockchain client server 220 and transmitting the at least one desired transaction smart contract to the blockchain node 240 in step S690, storing the at least one desired transaction smart contract in the blockchain node 240 in step S691, generating the desired transaction selection part 410, 510 for the consumer user interface by the second server 210 in step S692, accessing the second server 210 by the second consumer terminal 230 in step S693, and displaying the desired transaction selection part 410, 510 in the consumer user interface of the second consumer terminal 230 in step S694.

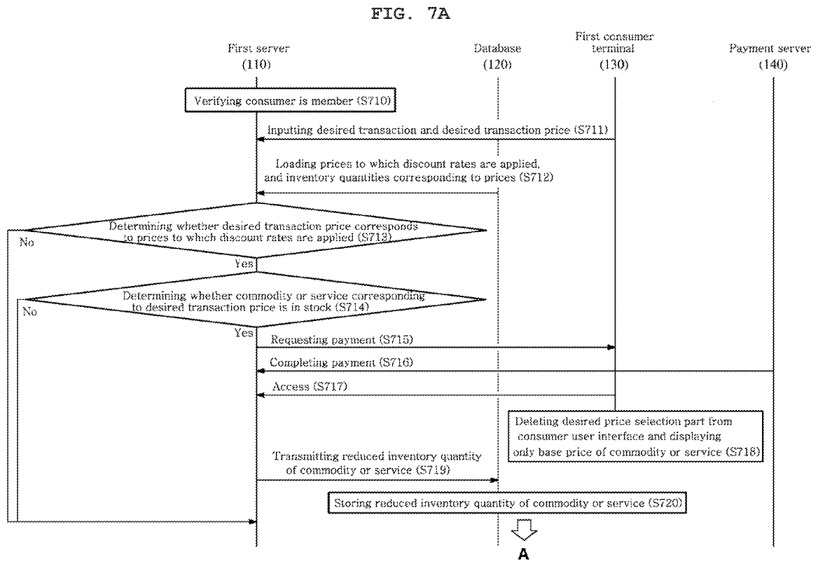

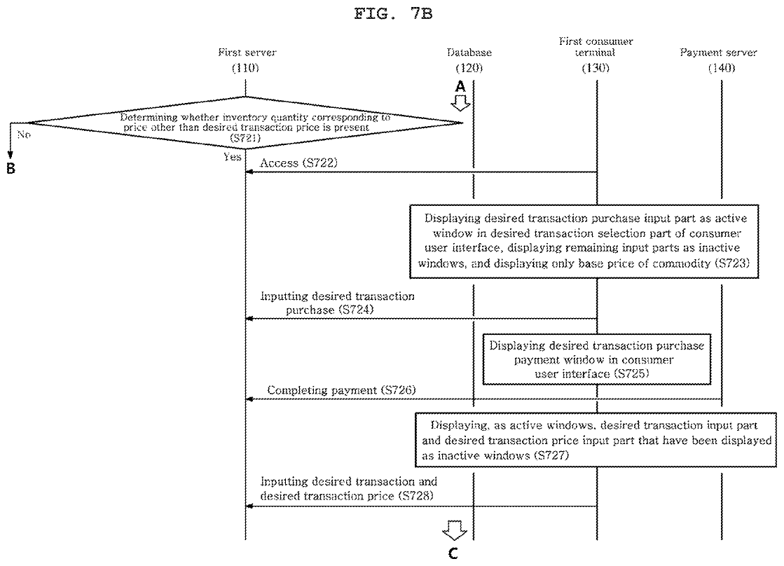

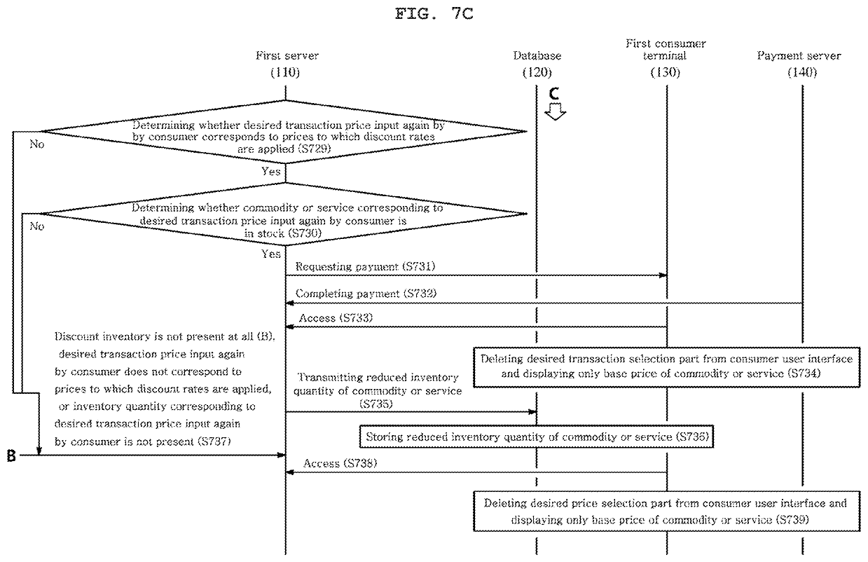

According to FIG. 7A, in a first exemplary embodiment of the transaction method by means of the electronic commerce system of the present disclosure, the first server 110 verifies that a consumer is a member in step S710, and when a desired transaction is input in the desired transaction input part 420 of the desired price selection part 410, 510 of the consumer user interface and a desired transaction price of a commodity or service is input in the desired transaction price input part 430, 520 in step S711, the first server 110 loads a plurality of prices to which a plurality of discount rates of the commodity or service are applied, and an inventory quantity corresponding to each of the plurality of prices stored in the database 120 in step S712.

According to FIG. 7A, the first server 110 determines whether the desired transaction price corresponds to any one of the prices to which the plurality of discount rates are applied in step S713, and determines whether the inventory quantity of the commodity or service corresponding to the desired transaction price is present in step S714.

According to FIG. 7A, when the desired transaction price corresponds to any one of the prices to which the plurality of discount rates are applied and the inventory quantity corresponding to the desired transaction price is present, the first server 110 makes a request to the first consumer terminal 130 for payment in step S715.

According to FIG. 7A, when the payment server 140 completes the payment in step S716 and the first consumer terminal 130 accesses the first server 110 in step S717, the first server 110 deletes the desired price selection part 410, 510 from the consumer user interface of the first consumer terminal 130 and displays only the base price of the commodity or service in step S718.

According to FIG. 7A, the first server 110 transmits the reduced inventory quantity of the commodity or service to the database 120 in step S719, and the database 120 stores therein the reduced inventory quantity of the commodity or service in step S720.

According to FIGS. 7A and 7B, when the desired transaction price does not correspond to any one of the prices to which the plurality of discount rates are applied or when the inventory quantity corresponding to the desired transaction price is not present, the first server 110 determines whether the inventory quantity corresponding to a price other than the desired transaction price among the prices to which the plurality of discount rates are applied is present in step S721.

According to FIG. 7B, when the inventory quantity corresponding to the price other than the desired transaction price is present and the first consumer terminal 130 accesses the first server 110 in step S722, the first server 110 displays the desired transaction purchase input part in the consumer user interface as an active window, displays the remaining input parts as inactive windows, and displays only the base price of the commodity or service in step S723.

According to FIG. 7B, when the desired transaction purchase input part 440 is entered in the consumer user interface in step S724, the desired transaction purchase payment window is displayed in the consumer user interface in step S725.

According to FIG. 7B, when the payment server 140 completes payment in step S726, the desired transaction input part 420 and the desired transaction price input part 430, 520 that have been displayed as inactive windows in the consumer user interface are displayed as active windows in step S727.

According to FIGS. 7B and 7C, when a desired transaction and a desired transaction price are input in the desired transaction input part 420 and the desired transaction price input part 430, 520 in step S728, it is determined whether the desired transaction price input again by the consumer corresponds to any one of the prices to which the plurality of discount rates are applied in step S729, and it is determined whether the inventory quantity of the commodity or service corresponding to the desired transaction price input again by the consumer is present in step S730.

According to FIG. 7C, when the desired transaction price input again by the consumer corresponds to any one of the prices to which the plurality of discount rates are applied and the inventory quantity of the commodity or service corresponding to the desired transaction price is present, a request for payment is made to the first consumer terminal 130 in step S731.

According to FIG. 7C, when the payment server 140 completes payment in step S732 and the first consumer terminal 130 accesses the first server 110 in step S733, the first server 110 deletes the desired transaction selection part 410, 510 from the consumer user interface and displays only the base price of the commodity or service in step S734.

According to FIG. 7C, the first server 110 transmits the reduced inventory quantity of the commodity or service to the database 120 in step S735, and the database 120 stores therein the reduced inventory quantity of the commodity or service in step S736.

According to FIG. 7C, in the case in which the inventory quantities corresponding to the prices to which the plurality of discount rates are applied are not present at all (B), the case in which the desired transaction price input again by the consumer does not correspond to any one of the prices to which the plurality of discount rates are applied, or the case in which the inventory quantity corresponding to the desired transaction price input again by the consumer is not present in step S737, when the first consumer terminal 130 accesses the first server 110 in step S738, the first server 110 deletes the desired price selection part from the consumer user interface and displays only the base price of the commodity or service in step S739.

For example, when a desired transaction price of the Samsung Galaxy X of 700,000 won to 750,000 won, of 760,000 won to 900,000 won, or of 1,000,000 won is input in the consumer user interface of the consumer terminal and the inventory quantity is present, the consumer may purchase the Samsung Galaxy X.

In addition, for example, when a desired transaction price of 690,000 won is input through the desired transaction price input part 430, 520 of the consumer user interface, this is the case in which the desired transaction price does not correspond to any one of the prices to which the plurality of discount rates are applied.

In addition, when the inventory quantities of all the discount sections including the first discount section (25% to 30%) ranging from 700,000 won to 750,000 won and the second discount section (10% to 24%) ranging from 760,000 won to 900,000 won are not present, this is the case in which the inventory quantities of the commodity or service corresponding to the plurality of discount rates are not present.

Accordingly, since the first exemplary embodiment of the transaction method by means of the electronic commerce system of the present disclosure relates to the case in which a plurality of prices to which a plurality of discount rates of a commodity or service are applied and the inventory quantity corresponding to each of the plurality of prices are stored in the database 120 and are not announced to a consumer, a manager of the first server 110 may change the inventory quantities of the commodity or service stored in the database 120.

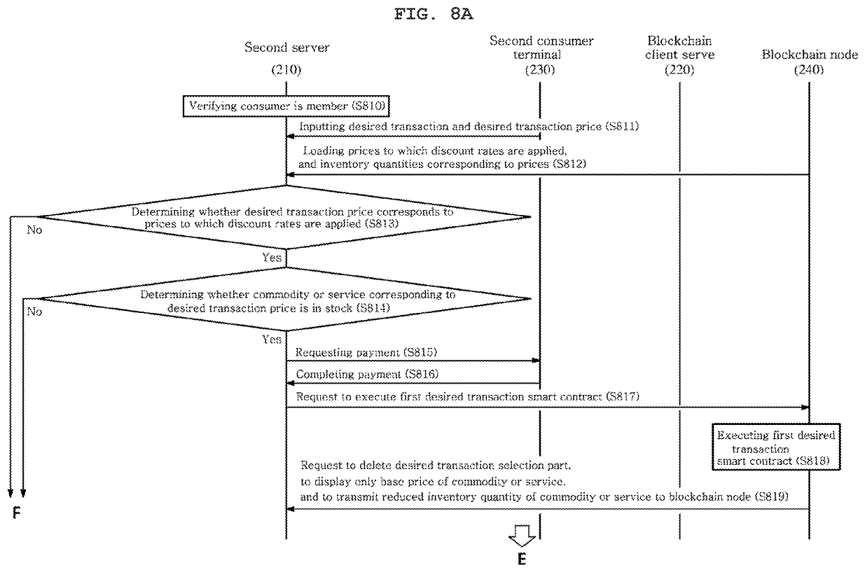

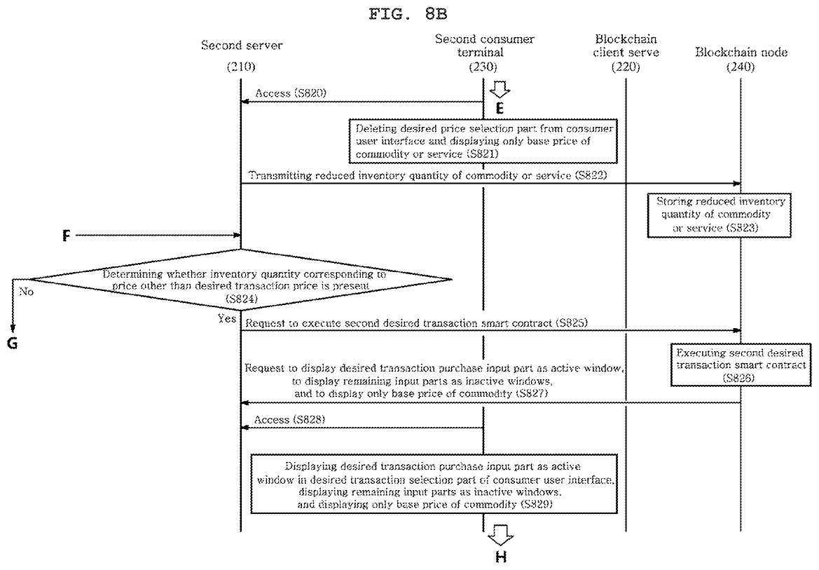

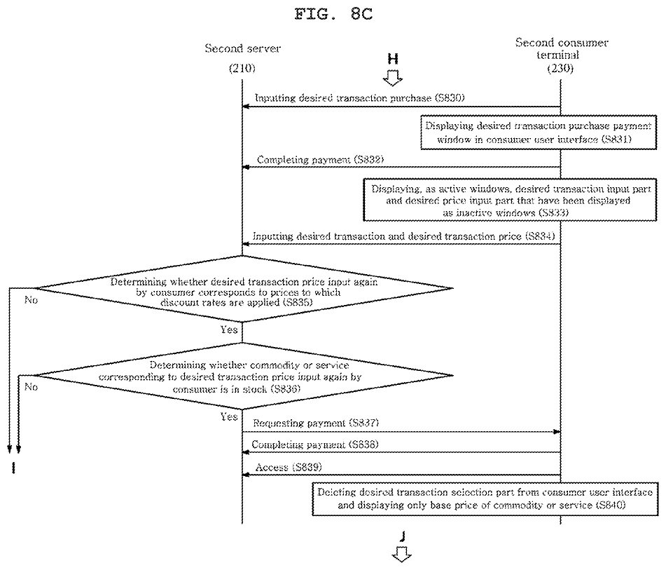

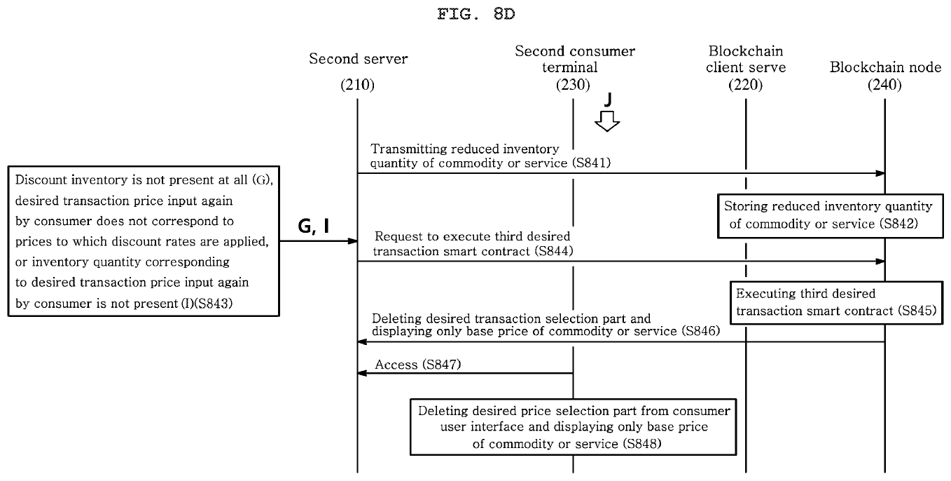

According to FIG. 8A, in a second exemplary embodiment of the transaction method by means of the electronic commerce system of the present disclosure, the second server 210 verifies that a consumer is a member in step S810, and when a desired transaction is input in the desired transaction input part 420 of the desired price selection part 410, 510 of the consumer user interface and a desired transaction price of a commodity or service is input in the desired transaction price input part 430, 520 in step S811, the second server 210 loads a plurality of prices to which a plurality of discount rates of the commodity or service are applied, and an inventory quantity corresponding to each of the plurality of prices stored in the blockchain node 240 in step S812.

According to FIG. 8A, the second server 210 determines whether the desired transaction price corresponds to any one of the prices to which the plurality of discount rates are applied in step S813, and determines whether the inventory quantity of the commodity or service corresponding to the desired transaction price is present in step S814.

According to FIG. 8A, when the desired transaction price corresponds to any one of the prices to which the plurality of discount rates are applied and the inventory quantity corresponding to the desired transaction price is present, the second server 210 makes a request to the second consumer terminal 230 for payment in step S815.

According to FIG. 8A, when the payment server 140 completes payment in step S816, the second server 210 requests the blockchain client server 220 to execute a first desired transaction smart contract in step S817, and the blockchain client server 220 requests the blockchain node 240 to execute the first desired transaction smart contract in step S817.

According to FIG. 8A, the blockchain node 240 requested by the blockchain client server 220 to execute the first desired transaction smart contract executes the first desired transaction smart contract in step S818.

According to FIG. 8A, the blockchain node 240 requests the second server 210 in step S819 to delete the desired transaction selection part 410, 510 from the consumer user interface, to display only the base price of the commodity or service, and to transmit the reduced inventory quantity of the commodity or service to the blockchain node 240.

According to FIG. 8B, when the second consumer terminal 230 accesses the second server 210 in step S820, the second server 210 deletes the desired price selection part 410, 510 from the consumer user interface of the second consumer terminal 230 and displays only the base price of the commodity or service in step S821.

According to FIG. 8B, the second server 210 transmits the reduced inventory quantity of the commodity or service to the blockchain node 240 in step S822, and the blockchain node 240 stores therein the reduced inventory quantity of the commodity or service in step S823.

According to FIG. 8B, when the desired transaction price does not correspond to any one of the prices to which the plurality of discount rates are applied or when the inventory quantity corresponding to the desired transaction price is not present, the second server 210 determines whether the inventory quantity corresponding to a price other than the desired transaction price among the prices to which the plurality of discount rates are applied is present in step S824.

According to FIG. 8B, when the desired transaction price does not correspond to any one of the prices to which the plurality of discount rates are applied, or when the inventory quantity corresponding to the desired transaction price is not present, but it is determined that the inventory quantity corresponding to a price other than the desired transaction price among the prices to which the plurality of discount rates are applied is present, the second server 210 requests the blockchain client server 220 to execute a second desired transaction smart contract in step S825, and the blockchain client server 220 requests the blockchain node 240 to execute the second desired transaction smart contract in step S825.

According to FIG. 8B, the blockchain node 240 requested by the blockchain client server 220 to execute the second desired transaction smart contract executes the second desired transaction smart contract in step S826.

According to FIG. 8B, the blockchain node 240 requests the second server 210 in step S827 to display the desired transaction purchase input part as an active window in the desired transaction selection part 410, 510 of the consumer user interface, to display the remaining input parts as inactive windows, and to display only the base price of the commodity or service.

According to FIG. 8B, when the second consumer terminal 230 accesses the second server 210 in step S828, the second server 210 displays the desired transaction purchase input part as an active window in the desired transaction selection part 410, 510 of the consumer user interface of the second consumer terminal 230, displays the remaining input parts as inactive windows, and displays only the base price of the commodity or service in step S829.

According to FIG. 8C, when the desired transaction purchase input part is input in the consumer user interface in step S830, the desired transaction purchase payment window is displayed in the consumer user interface in step S831.

According to FIG. 8C, when the cryptocurrency wallet 233 of the second consumer terminal 230 completes payment in step S832, the desired transaction input part 420 and the desired transaction price input part 430, 520 that have been displayed as inactive windows in the consumer user interface are displayed as active windows in step S833.

According to FIG. 8C, when a desired transaction and a desired transaction price are input in the desired transaction input part 420 and the desired transaction price input part 430, 520 in step S834, it is determined whether the desired transaction price input again by the consumer corresponds to any one of the prices to which the plurality of discount rates are applied in step S835, and it is determined whether the inventory quantity of the commodity or service corresponding to the desired transaction price input again by the consumer is present in step S836.

According to FIG. 8C, when the desired transaction price input again by the consumer corresponds to any one of the prices to which the plurality of discount rates are applied and the inventory quantity of the commodity or service corresponding to the desired transaction price is present, a request for payment is made to the second consumer terminal 230 in step S837.

According to FIG. 8C, when the cryptocurrency wallet 233 of the second consumer terminal 230 completes payment in step S838 and the second consumer terminal 230 accesses the second server 210 in step S839, the second server 210 deletes the desired transaction selection part 410, 510 from the consumer user interface and displays only the base price of the commodity or service in step S840.

According to FIG. 8D, the second server 210 transmits the reduced inventory quantity of the commodity or service to the blockchain node 240 in step S841, and the blockchain node 240 stores therein the reduced inventory quantity of the commodity or service in step S842.

According to FIG. 8D, when the inventory quantities corresponding to the prices to which the plurality of discount rates are applied are not present at all (G), when the desired transaction price input again by the consumer does not correspond to any one of the prices to which the plurality of discount rates are applied, or when the inventory quantity corresponding to the desired transaction price input again by the consumer is not present (I) in step S843, the second server 210 requests the blockchain client server 220 to execute a third desired transaction smart contract in step S844. The blockchain client server 220 requests the blockchain node 240 to execute the third desired transaction smart contract in step S844.

According to FIG. 8D, the blockchain node 240 executes the third desired transaction smart contract in step S845, and requests the second server 210 in step S846 to delete the desired transaction selection part 410, 510 and to display only the base price of the commodity or service.

According to FIG. 8D, when the second consumer terminal 230 accesses the second server 210 in step S847, the second server 210 deletes the desired transaction selection part 410, 510 from the consumer user interface and displays only the base price of the commodity or service in step S848.

Accordingly, in the second exemplary embodiment of the transaction method by means of the electronic commerce system of the present disclosure, while a plurality of prices to which a plurality of discount rates of a commodity or service are applied, an inventory quantity corresponding to each of the plurality of prices, and an inventory quantity reduced with sale to a consumer are stored in the blockchain node 240 and are not announced, the desired transaction selection part 410, 510 of the consumer user interface is deleted by choice according to the execution conditions of a first to third desired transaction smart contracts, and only the base price of the commodity or service is displayed. Therefore, in any case, the discount rates and discount quantities once set by a seller are not changed, so that a consumer who wants to receive an appropriate discount has trust and makes a purchase.

In addition, in the second exemplary embodiment of the transaction method by means of the electronic commerce system of the present disclosure, automation is achieved from a seller's point of view as appropriate discount rates are applied and the discount rates are never announced, so the transaction method can be effectively used for home shopping or online sales.

The embodiments of the present disclosure have been described for illustrative purpose, and those skilled in the art to which the present disclosure pertains will easily understand that the present disclosure may be modified in various ways and that other equivalent embodiments are possible. Accordingly, the true range of protection of the present disclosure should be determined by the following claims.

1: An electronic commerce system for proposing a personally-desired transaction price, the system comprising:
a consumer terminal configured to input a desired transaction price in a desired transaction selection part of a consumer user interface for a consumer;
a server; and
a database configured to store therein selling information of a commodity or service input from the server, and inventory quantities to which a selling result of the commodity or service is applied,
wherein the server comprises:
an input and output module comprising a seller user interface configured to input and display the selling information of the commodity or service on a display screen,
a price setting module configured to set a plurality of discount rates and discount quantities corresponding to the plurality of discount rates included in the selling information of the commodity or service, and
a control communication module configured to:
store the plurality of discount rates and the discount quantities corresponding to the plurality of discount rates in the database;
determine whether the desired transaction price corresponds to any one of prices to which the plurality of discount rates are applied and whether the inventory quantity corresponding to the desired transaction price is present; and
delete the desired transaction selection part from the consumer user interface and display only a base price of the commodity or service when the desired transaction price corresponds to any one of the prices to which the plurality of discount rates are applied and the inventory quantity corresponding to the desired transaction price is present and payment by the consumer is confirmed.

2: The system of claim 1, wherein the input and output module further comprises an input window for the number of desired transactions and an input window for whether to allow addition of a desired transaction.

3: The system of claim 1, wherein the plurality of discount rates include at least one discount section, and the discount section is a section that is generated including two different discount rates among the plurality of discount rates and connecting the two different discount rates compared with the base price of the commodity or service.

4: The system of claim 1, wherein the control communication module is further configured to:
display a desired transaction purchase input part as an active window in the consumer user interface when the inventory quantity corresponding to the desired transaction price is not present, but the inventory quantity corresponding to a price other than the desired transaction price among the prices to which the plurality of discount rates are applied is present;
display a desired transaction purchase payment window in the consumer user interface when the consumer selects the desired transaction purchase input part;
display a desired transaction input part and a desired transaction price input part that have been displayed as inactive windows, as active windows when the consumer completes payment;
load the inventory quantities stored in the database when the consumer selects the desired transaction input part and inputs a desired transaction price, so as to determine whether the desired transaction price corresponds to any one of the prices to which the plurality of discount rates are applied and whether the inventory quantity corresponding to the desired transaction price is present; and
delete a desired price selection part from the consumer user interface and display only the base price of the commodity or service when the desired transaction price corresponds to any one of the prices to which the plurality of discount rates are applied and the inventory quantity corresponding to the desired transaction price is present.

5: The system of claim 1, wherein the control communication module is further configured to store, when the desired transaction price corresponds to any one of the prices to which the plurality of discount rates are applied and the inventory quantity corresponding to the desired transaction price is present and the payment by the consumer is confirmed, the inventory quantity reduced by a sales quantity and the discount rates of the respective inventory quantities in the database.

6: The system of claim 4, wherein the control communication module is further configured to delete the desired price selection part from the consumer user interface and display only the base price of the commodity or service when the inventory quantities corresponding to the prices to which the plurality of discount rates are applied are not present or when the inventory quantity of the price corresponding to the desired transaction price input by the consumer is not preset after the desired transaction input part and the desired transaction price input part that have been displayed as the inactive windows are displayed as the active windows.

7: An electronic commerce system for proposing a personally-desired transaction price, the system comprising:
a consumer terminal configured to input a desired transaction price in a desired transaction selection part of a consumer user interface for a consumer;
a server;
a blockchain client server configured to store, in a blockchain node, selling information of a commodity or service input from the server, inventory quantities to which a selling result of the commodity or service is applied, and at least one desired transaction smart contract; and
the blockchain node configured to store therein the selling information of the commodity or service, the inventory quantities to which the selling result of the commodity or service is applied, and the at least one desired transaction smart contract,
wherein the server comprises:
an input and output module comprising a seller user interface configured to input and display the selling information of the commodity or service on a display screen,
a price setting module configured to set a plurality of discount rates and discount quantities corresponding to the plurality of discount rates included in the selling information of the commodity or service, and
a control communication module configured to:
store the plurality of discount rates and the discount quantities corresponding to the plurality of discount rates in the blockchain node;
determine whether the desired transaction price corresponds to any one of prices to which the plurality of discount rates are applied and whether the inventory quantity corresponding to the desired transaction price is present;
make a request to execute a first desired transaction smart contract stored in the blockchain node when the desired transaction price corresponds to any one of the prices to which the plurality of discount rates are applied and the inventory quantity corresponding to the desired transaction price is present and payment by the consumer is confirmed; and
delete the desired transaction selection part from the consumer user interface and display only a base price of the commodity or service as the first desired transaction smart contract stored in the blockchain node is executed.

8: The system of claim 7, wherein the control communication module is further configured to:
make a request to execute a second desired transaction smart contract stored in the blockchain node when the inventory quantity corresponding to the desired transaction price is not present, but the inventory quantity corresponding to a price other than the desired transaction price among the prices to which the plurality of discount rates are applied is present;
display a desired transaction purchase input part as an active window in the consumer user interface as the second desired transaction smart contract is executed;
display a desired transaction purchase payment window in the consumer user interface when the consumer selects the desired transaction purchase input part;
display a desired transaction input part and a desired transaction price input part that have been displayed as inactive windows, as active windows when the consumer completes payment;
load the inventory quantities stored in the blockchain node when the consumer selects the desired transaction input part and inputs a desired transaction price, so as to determine whether the desired transaction price corresponds any one of the prices to which the plurality of discount rates are applied and whether the inventory quantity corresponding to the desired transaction price is present; and
delete a desired price selection part from the consumer user interface and display only the base price of the commodity or service when the desired transaction price corresponds to any one of the prices to which the plurality of discount rates are applied and the inventory quantity corresponding to the desired transaction price is present and payment by the consumer is confirmed.

9: The system of claim 7, wherein the control communication module is further configured to store, when the desired transaction price corresponds to any one of the prices to which the plurality of discount rates are applied and the inventory quantity corresponding to the desired transaction price is present and the payment by the consumer is confirmed, the inventory quantity reduced by a sales quantity and the discount rates of the respective inventory quantities in the blockchain node as the first or second desired transaction smart contract stored in the blockchain node is executed.

10: The system of claim 8, wherein the control communication module is further configured to:
make a request to execute a third desired transaction smart contract stored in the blockchain node when the inventory quantities corresponding to the prices to which the plurality of discount rates are applied are not present or when the inventory quantity of the price corresponding to the desired transaction price input by the consumer is not present after the desired transaction input part and the desired transaction price input part that have been displayed as the inactive windows are displayed as the active windows; and
delete the desired price selection part from the consumer user interface and display only the base price of the commodity or service as the third desired transaction smart contract stored in the blockchain node is executed.

11: A method for a transaction with an electronic commerce system for proposing a personally-desired transaction price, the method comprising:
inputting a desired transaction price of a commodity or service in a desired price selection part of a consumer user interface for a consumer;
loading inventory quantities of the commodity or service stored in a database to determine whether the desired transaction price of the commodity or service corresponds to any one of prices to which a plurality of discount rates are applied and whether the inventory quantity corresponding to the desired transaction price is present; and
deleting the desired price selection part from the consumer user interface and displaying a base price of the commodity or service when the desired transaction price corresponds to any one of the prices to which the plurality of discount rates are applied and the inventory quantity corresponding to the desired transaction price is present and payment by the consumer is confirmed.

12: The method of claim 11, wherein a desired transaction purchase input part is displayed as an active window in the consumer user interface when the inventory quantity corresponding to the desired transaction price is not present, but the inventory quantity corresponding to a price other than the desired transaction price among the prices to which the plurality of discount rates are applied is present;
a desired transaction purchase payment window is displayed in the consumer user interface when the consumer selects the desired transaction purchase input part;
a desired transaction input part and a desired transaction price input part that have been displayed as inactive windows are displayed as active windows when the consumer completes payment;
the inventory quantities stored in the database are loaded when the consumer selects the desired transaction input part and inputs a desired transaction price, so as to determine whether the desired transaction price corresponds to any one of the prices to which the plurality of discount rates are applied and whether the inventory quantity corresponding to the desired transaction price is present; and
the desired price selection part is deleted from the consumer user interface and only the base price of the commodity or service is displayed when the desired transaction price corresponds to any one of the prices to which the plurality of discount rates are applied and the inventory quantity corresponding to the desired transaction price is present.

13: The method of claim 11, further comprising storing, when the desired transaction price corresponds to any one of the prices to which the plurality of discount rates are applied and the inventory quantity corresponding to the desired transaction price is present, the inventory quantity reduced by a sales quantity and the discount rates of the respective inventory quantities in the database.

14: The method of claim 12, wherein the desired price selection part is deleted from the consumer user interface and only the base price of the commodity or service is displayed when the inventory quantities corresponding to the prices to which the plurality of discount rates are applied are not present or when the inventory quantity of the price corresponding to the desired transaction price input by the consumer is not preset after the desired transaction input part and the desired transaction price input part that have been displayed as the inactive windows are displayed as the active windows.

15: A method for a transaction with an electronic commerce system for proposing a personally-desired transaction price, the method comprising:
inputting a desired transaction price of a commodity or service in a desired price selection part of a consumer user interface for a consumer;
loading inventory quantities stored in a blockchain node to determine whether the desired transaction price corresponds to any one of prices to which a plurality of discount rates are applied and whether the inventory quantity corresponding to the desired transaction price is present;
making a request to execute a first desired transaction smart contract stored in the blockchain node when the desired transaction price corresponds to any one of the prices to which the plurality of discount rates are applied and the inventory quantity corresponding to the desired transaction price is present and payment by the consumer is confirmed; and
deleting a desired transaction selection part from the consumer user interface and displaying only a base price of the commodity or service as the first desired transaction smart contract stored in the blockchain node is executed.

16: The method of claim 15, wherein a request to execute a second desired transaction smart contract stored in the blockchain node is made when the inventory quantity corresponding to the desired transaction price is not present, but the inventory quantity corresponding to a price other than the desired transaction price among the prices to which the plurality of discount rates are applied is present;
a desired transaction purchase input part is displayed as an active window in the consumer user interface as the second desired transaction smart contract is executed;
a desired transaction purchase payment window is displayed in the consumer user interface when the consumer selects the desired transaction purchase input part;
a desired transaction input part and a desired transaction price input part that have been displayed as inactive windows are displayed as active windows when the consumer completes payment;
the inventory quantities stored in the blockchain node are loaded when the consumer selects the desired transaction input part and inputs a desired transaction price, so as to determine whether the desired transaction price corresponds any one of the prices to which the plurality of discount rates are applied and whether the inventory quantity corresponding to the desired transaction price is present; and
the desired price selection part is deleted from the consumer user interface and only the base price of the commodity or service is displayed when the desired transaction price corresponds to any one of the prices to which the plurality of discount rates are applied and the inventory quantity corresponding to the desired transaction price is present and payment by the consumer is confirmed.

17: The method of claim 15, further comprising storing, when the desired transaction price corresponds to any one of the prices to which the plurality of discount rates are applied and the inventory quantity corresponding to the desired transaction price is present and the payment by the consumer is confirmed, the inventory quantity reduced by a sales quantity and the discount rates of the respective inventory quantities in the blockchain node as the first or second desired transaction smart contract stored in the blockchain node is executed.

18: The method of claim 16, wherein a request to execute a third desired transaction smart contract stored in the blockchain node is made when the inventory quantities corresponding to the prices to which the plurality of discount rates are applied are not present or when the inventory quantity of the price corresponding to the desired transaction price input by the consumer is not present after the desired transaction input part and the desired transaction price input part that have been displayed as the inactive windows are displayed as the active windows; and
the desired price selection part is deleted from the consumer user interface and only the base price of the commodity or service is displayed as the third desired transaction smart contract stored in the blockchain node is executed.
